(19) United States
(12) Patent Application Publication
(10) Pub. No.: US 2004/0166874 A1
(43) Pub. Date: Aug. 26, 2004

(54) Location related information in mobile communication system

(76) Inventors: Nadarajah Asokan, Espoo (FI); Timo M. Rantalainen, Helsinki (FI); Philip Ginzboorg, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/705,396

(22) Filed: Nov. 12, 2003

Related U.S. Application Data
(60) Provisional application No. 60/426,017, filed on Nov. 14, 2002.

(51) Int. Cl. H04Q 7/20

(52) U.S. Cl. 455/456.1; 455/433

(57) ABSTRACT

In order to deliver to subscriber's user equipment network-specific information required for a service or for requesting a service in the mobile communication network, where the subscriber's user equipment is currently located, either at least part of the information required for the service is transmitted to the user equipment after the subscriber has been authenticated or the address of a network node is determined (2-9) on the basis of the subscriber's location information.

### REFERENCE TO RELATED APPLICATIONS

This application claims priority of U.S. Provisional Patent Application Serial No. 60/426,017, filed on Nov. 14, 2002, the contents of which are hereby incorporated by reference.

### BACKGROUND OF THE INVENTION

1. Field of the Invention

The invention relates to information the content of which may depend on the subscriber's location, such as information needed for certificate requests in a visited network when a subscriber is roaming within the service area of a mobile communication system. The mobile communication system generally refers to any telecommunication system which enables wireless communication with a user when a user is located within the service area of the system.

2. Description of the Related Art

Telecommunication systems, particularly mobile communication systems, are developing at an increasing pace. While the telecommunication systems have evolved, also services provided via the systems have been under development. Many services, for example services involving financial transactions, employ digital certificates, hereinafter called certificates, to dynamically establish a level of trust between the parties, i.e. a trust relationship between a service provider and a subscriber using the service. By issuing certificates to subscribers an operator can also offer authorization and accounting as a value-added service to other service providers. A certificate is a proof normally supplied by a third party, usually a certification authority (CA), to confirm that a digital signature belongs to a certain person or organization and is valid.

One of the problems associated with certificates in a mobile communication system originates from the subscribers' ability to move within the service area of the system. Each subscriber of a mobile communication system is usually associated with one part of the system, which serves as the home network for that subscriber. The home network is a mobile network in whose home location register a mobile subscriber is permanently registered upon subscription, and the home network performs various subscription-related functions, such as storing subscription data and billing. A subscriber in a service area of a visited network, i.e. a network different from his home network, may need a certificate issued by the operator of the visited network, for example when he wishes to use services provided by a service provider who has a contractual relationship with the visited network operator but not with the home network operator. In order to obtain the certificate, some network-specific information may be required, such as the address of the network node via which certificate requests are routed in the visited network or a public key used in certificate issuance. However, these are typically not known by the subscriber (or his user equipment), and thus the information needs to be found out somehow.

### SUMMARY OF THE INVENTION

An object of the present invention is to provide a method and an apparatus for implementing the method which solves the problem of how the information is obtained. The object of the invention is achieved by methods and a system which are characterized by what is stated in the independent claims. The preferred embodiments of the invention are disclosed in the dependent claims.

### BRIEF DESCRIPTION OF THE DRAWINGS

In the following the invention will be described in greater detail by means of preferred embodiments with reference to the attached drawings, in which

FIG. 1 shows an exemplary system architecture;

FIG. 2 illustrates signaling according to embodiment one of the invention; and

FIG. 3 illustrates signaling according to embodiment two of the invention.

### DETAILED DESCRIPTION OF THE INVENTION

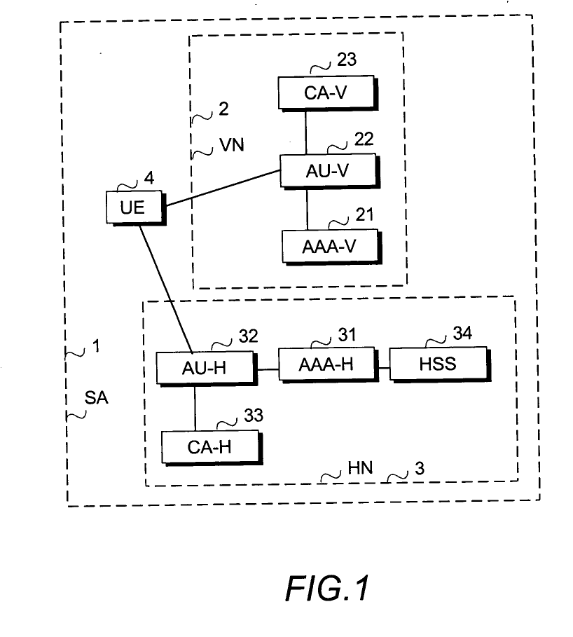

The present invention is applicable to any telecommunication system, and especially to systems providing services that require certificates or through which certificates may be delivered to the end user. Such systems include for instance what are called third generation mobile systems, such as the UMTS (Universal Mobile Communication System), WLAN (wireless local area network) based systems and systems based on GSM (Global System for Mobile communication) or corresponding systems, such as GSM 2+ systems and the future 4^{th} generation systems. In the following, the invention will be described by using an exemplary system disclosed in FIG. 1 without restricting the invention thereto. The specifications of telecommunication systems and particularly wireless telecommunication systems develop rapidly. Such development may require extra changes to the invention. Therefore, all words and expressions should be interpreted broadly and they are intended to illustrate, not restrict the invention.

FIG. 1 shows a simplified network architecture and only shows some elements of the architecture of a system illustrated in FIG. 1. The network nodes shown in FIG. 1 are logical units whose implementation may differ from what is shown. The logical units may be combined to each other, i.e. a functionality of one logical unit described below may be enhanced to comprise a functionality of another logical unit described below and/or a functionality of a prior art network node (logical unit). The connections shown in FIG. 1 between network nodes are logical connections; the actual physical connections may be different than the logical connections. It is apparent to a person skilled in the art that the systems comprise also other functions and structures that need not be described in detail herein.

The system SA 1 comprises a visited network VN 2 and a home network HN 3 for a subscriber using user equipment UE 4. The visited network VN 2 comprises an AAA (Authorization, Authentication, Accounting) server AAA-V 21, a network node AU-V 22 for the certificate procedure and a certification authority CA-V 23. The home network HN 3 comprises an AAA server AAA-H 31 with which the UE 4 has static (permanent) trust, a network node AU-H 32 for the certificate procedure, a certification authority CA-H 33 and an HSS 34. It bears no significance to the invention how the UE 4 is connected to the system infrastructure, how the logical connection between the UE 4 and the AU-H 32 is established and how different nodes, networks, authorities and servers are interconnected and therefore the connection alternatives are not discussed here. However, all network nodes and certification authorities are preferably part of network domain security (NDS) so that secure communication between the certification authority CA, the AU and the AAA server can be provided.

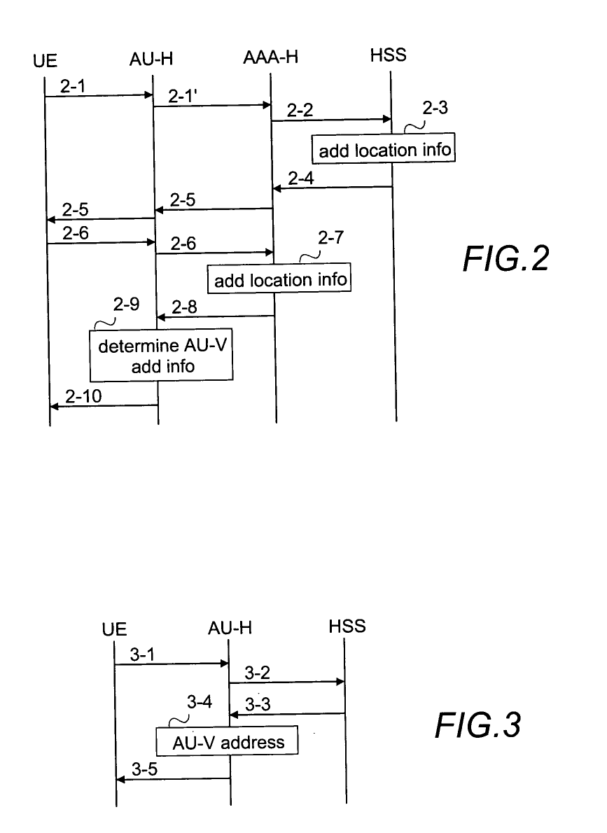

The user equipment UE 4, i.e. the terminal, may be any mobile node or a mobile host which can communicate over the mobile network. It can be, for example, a speech-only mobile station, a multi-service terminal that serves as a service platform and supports the loading and execution of different functions related to services, or a laptop PC connected to a cellular phone capable of packet radio operation. Other embodiments of the UE 4 include various pagers, remote-controllers, monitoring and/or data acquisition devices, etc. In this context, the user equipment UE 4 generally refers to a combination of an actual terminal and a user of the terminal, i.e. as regards mobile phones, to a combination of a mobile unit and a mobile subscriber, who is identified in the system by e.g. a SIM (Subscriber Identity Module) card detachably coupled to the mobile unit. The SIM card is a smart card that holds the subscriber identity, performs authentication algorithms, and stores authentication and encryption keys and some subscription information that is needed in the mobile station. The address of the AU in the home network, i.e. AU-H 32 may be stored in the UE 4, preferably to the SIM. The features of the UE 4 in different embodiments of the invention are disclosed below with FIGS. 2 and 3.

The certification authority CA provides the transaction parties with certificates, i.e. it is the trusted third party. Typically each network has its own CA. For example, the home network HN 3 in FIG. 1 comprises CA-H 33 and the visited network comprises CA-V 23. The implementation of different certificate functions, including issuing, generating, signing and usage of certificates and the manner how and the place from which the issued certificates are obtained are not significant to the invention. Other details relating to the certificates, such as how they are used and what for or where they are stored, are of no importance to the invention either.

The new logical network node, authenticator AU, is a certificate provisioning gateway for the UE 4. The AU is a network node for the certificate issuing and delivery procedure. The AU may locate in a new physical node comprising only the AU or it may locate in a physical node comprising also another (other) logical network node(s). Typically each AU serves one CA. However, it is also possible that two or more CAs share one AU. The features of the AU-H 32 and/or the AU-V 22 in different embodiments of the invention are disclosed below with FIGS. 2 and 3.

The AAA server in the home network, AAA-H 31, may comprise subscription data that can be used during authentication of the user equipment, i.e. the subscriber. The AAA-H 31 may download this data from HSS 34. The AAA server in the visited network, AAA-V 21, may also comprise required subscription data of a roaming UE 4, the data being downloaded during registration of the UE 4, for example. In other words, the AAA-H 31 may transfer data to the AAA-V 21 or to the AU. The AAA server AAA-V 21 is also called an AAA proxy. When the UE 4 is roaming, the AAA-V 21 may be utilized for obtaining authentication data via the AAA-H 31. The AAA server may correspond to a home location register or a visitor location register of the GSM system, or it may be based on an LDAP (Lightweight Directory Access Protocol) server or it can be an application specific server, a Diameter server or a Radius server, for example. The features of the AU-H 32 and/or the AU-V 22 in different embodiments of the invention are disclosed below with FIGS. 2 and 3.

The subscription data of a subscriber, also called subscriber information, is stored permanently or semi-permanently in a memory of a register called the HSS 34 in such a manner that the subscription data is connected to the subscriber's identifier IMSI or to another corresponding identifier identifying the subscriber. The subscription data includes routing information, i.e. the current location of the subscriber, and information on the services the subscriber can access. The features of the HSS 34 in different embodiments of the invention are disclosed below with FIGS. 2 and 3.

Since there are various ways to implement the AAA servers and the new elements AU-H 32 and AU-V 22, the following is only an example illustrating interfaces and protocols that can be used in the SA 1. It is obvious that the UE 4 and the nodes need to support their interfaces and protocols. The security of the interface between the UE 4 and the AUs, i.e. the AU-H 32 and the AU-V 22, is based on the authentication method of the system SA 1 and therefore the interface may be EAP AKA (extensible authentication protocol, authentication and key agreement) providing means to exchange messages related to AKA authentication encapsulated within the extensible authentication protocol (EAP). Another possibility is HTTP Digest AKA when the underlying authentication protocol for user authentication for certificate requests is AKA. After a security association between UE 4 and the authenticator has been created, e.g. with EAP AKA, IPSec (Internet Protocol Security) or PIC (Pre-IKE (Internet key exchange) credential provisioning protocol) can be used between the UE 4 and the AUs, i.e. the AU-H 32 and the AU-V 22, for transferring requests and responses, such as certificate requests and certificate responses, over an authenticated and integrity protected channel. The interfaces between the AAA-V 21 and the AAA-H 31, between the AAA-V 21 and the AU-V 22, between the AAA-H 31 and the AU-H 32 and between the AAA-H 31 and the HSS 34 are preferably Diameter interfaces. The interface between the AU and the corresponding CA, i.e. between the AU-H 32 and the CA-H 33 and between the AU-V 22 and the CA-V 23, may be a new interface or it may be based on existing interfaces, such as PKCS#10 disclosed in the document having the following Internet address: http://www.rsasecurity.com/rsalabs/Pkcs/pkcs-10/. The document is incorporated herein as a reference.

The advantages of using the system SA 1 of FIG. 1 to implement the present invention are that the system is access independent, it is technically feasible since the new node AU has no arbitrary constraints, and therefore anything can be specified and designed. Furthermore, the SA 1 enables synergies with WLAN (wireless local area network) security solutions, and changes to an application layer of the system are easier to build on top of existing terminals supporting e.g. WIM (Wireless Identity Module) and USIM (UMTS SIM). A further advantage is that when using the system SA 1 no changes are needed in the existing cellular protocols and network nodes. However, the invention may be implemented in other access independent systems or in access dependent systems by modifying network nodes and/or by adding functions of the invention to the networks nodes. Examples of other systems are a 3GPP AII-IP system based on the IP (Internet Protocol) technology, specified in the third generation partnership project 3GPP and a system utilizing IMS (IP Multimedia Subsystem) providing multimedia services which are usually, although not necessarily, Internet-based services employing a packet protocol. If required, more detailed descriptions of some system architecture examples can be found on the home page of the third generation partnership project 3GPP and especially in the document the Internet address of which is http://www.3gpp.org/ftp/tsg_sa/WG2_Arch/TSGS2_{—}27/tdocs/s2-022854.zip. The document is incorporated herein as a reference.

FIGS. 2 and 3 illustrate signaling principles according to different embodiments of the invention. The exemplary service used with FIGS. 2 and 3 is a service requiring certificates. Furthermore, in the examples illustrated in FIGS. 2 and 3, it is assumed that in order to request a certificate, the address of the AU connected to the certification authority CA is the one used to route the certificate requests. The UE represents in FIGS. 2 and 3 a subscriber requesting a certificate. The signaling messages and points shown in FIGS. 2 and 3 are simplified and aim only at describing the idea of the invention. Therefore nodes and signaling to which the inventive functionality is transparent are not necessarily shown in Figures. In other words, nodes via which signaling messages are transmitted and nodes which may map a signaling message of protocol one to a signaling message of protocol two, i.e. nodes performing prior art functions, and corresponding signaling messages are not described in FIGS. 2 and 3. Other signaling messages may be sent and/or other functions carried out between the messages and/or the points. The order of the signaling messages and/or points may differ from what will be described below. The signaling messages serve only as examples and they may contain only some of the information mentioned below. The messages may also include other information. Furthermore, the names of the signaling messages may be different and other protocols may be used.

Embodiment One

FIG. 2 illustrates signaling according to embodiment one of the invention. In embodiment one the AAA-H does not comprise subscription data or authentication information.

In FIG. 2 an application level authentication has been triggered. The application level authentication may be triggered because the UE wants to use a service requiring a certificate from the visited network, for example. In other words FIG. 2 illustrates a situation where the UE wants to use a service that requires that the UE be authenticated towards the network, and during (or in connection with) authentication the UE receives information which is needed for the service. In the example of FIG. 2 it is assumed that authentication is always performed via the AU in the home network, i.e. via the AU-H. In FIG. 2 it is assumed that the address of the AU-H is stored to the UE (preferably to the subscriber identity module).

The UE generates authentication message 2-1 comprising the subscriber's identity information and sends message 2-1 to the AU-H. The message 2-1 may be an EAP-Response/Identity message with the subscriber's NAI (Network Access Identifier), for example. The AU-H forwards message 2-1 to the AAA-H, i.e. to the AAA server in the home network. The forwarded message 2-1 may be a Diameter message, for example.

In response to receiving message 2-1, the AAA-H requests subscription data and authentication information from the HSS in message 2-2, which may be a Diameter message, for example. In the embodiment one of the invention, the HSS is arranged to add, at point 2-3, to the response message requested subscription data, authentication information and the location information of the UE. The location information may be a label for the network or a domain, or an address of a serving node, i.e. anything which defines the location of the UE accurately enough. When the response message 2-4 is formed, the HSS sends message 2-4 to the AAA-H. Message 2-4 may be a Diameter message, for example. The requested subscription data means here the part of the subscription data needed, e.g. the whole subscription data or only the data indicating whether or not it is allowed to issue certificates for the subscriber.

Messages 2-5, 2-6, 2-7 and 2-8 illustrate normal information exchange during authentication. A person skilled in the art is familiar with the authentication procedure and therefore authentication details are not discussed in detail here. Furthermore, the details of the authentication procedure are irrelevant for the invention. Briefly, the AAA-H sends to the AU-H message 2-5 having attributes used in the authentication, such as random challenge RAND and authentication token AUTN. Message 2-5 may be a Diameter message, for example. The AU-H forwards message 2-5 to the UE. The forwarded message 2-5 may be an EAP-Request/AKA-challenge message, for example. The UE computes, on the basis of the RAND and AUTN, a response RES and sends the RES in message 2-6 to the AU-H. Message 2-6 may be an EAP-Response/AKA-challenge message, for example. The AU-H forwards message 2-6 to the AAA-H. The forwarded message 2-6 may be a Diameter message, for example.

The AAA-H verifies the RES the AAA-H received in message 2-6. In this example it is assumed that the verification is successful, and therefore the AAA-H forms, at point 2-7, message 2-8 indicating successful authentication and adds, at point 2-7, to message 2-8 the necessary subscription data, such as whether this subscriber is allowed to obtain a certificate through a mobile network, and the location information of the UE. After that the AAA-H sends message 2-8 to the AU-H. Message 2-8 may be a Diameter message, for example.

In embodiment one of the invention, the AU-H determines, at point 2-9, the address of the AU-V on the basis of the location information it received in message 2-8. The AU-H preferably comprises a mapping table for pairs formed by the location information and the AU-V address, the mapping table also comprising in embodiment one other relevant information, such as information on the protocol(s) to be used with the AU-V, the public key of the AU-V, a certificate of the AU-V, and/or other security related parameters, for each pair. Another possibility is that the AU-H inquires the address and other relevant information from a network node having the mapping table or corresponding information, the network node being preferably in the home network. The mapping table may comprise only location information with address information, only location information with with some relevant information or location information with address information and some relevant information. For example, for location information “operator 1” the mapping table may contain address information, such as certificate.authority@operator1.fi, or a public key, e.g. 123567E97, or both of them.

When the address is determined, the AU-H adds, at point 2-9, the address of the AU-V and the other relevant information to the message indicating successful authentication, i.e message 2-10, and sends message 2-10 to the UE. The UE receives in message 2-10 information which can be used, for example, when the UE requests for certificates in the visited network.

After that the UE and the AU-H can set up a security association, such as an IPSec security association, and the UE may send a certificate request either to the AU in the home network or to the AU in the visited network. How the security association is set up bears no significance to the invention.

In another embodiment of the invention, the AU-H may be configured to add, at point 2-9, only part of the relevant information, for example only the public key of the AU-V or the protocol(s) or both of them but not the address of the AU-V.

By sending the public key in message 2-10 a problem relating to the use of the PIC protocol for obtaining a digital certificate is solved. The usage of PIC between two elements only requires that the elements be IP-capable entities connected to interconnected networks. The PIC sets up an authenticated encrypted connection between the terminal and the server. However, the PIC requires that the server, i.e. the AU, be authenticated on the basis of the digital signature of the server. In order to verify the server's signature, the UE needs to know, or be able to validate, the server's public key. The public key in the home network may be stored in the UE, but embodiment one provides one solution how the UE can be informed about the server's public key in the visited network.

Another advantage of embodiment one is that UE can be sure that the information received in message 2-10 is valid, since the message exchange is authenticated and integrity protected based on e.g. AKA. If the AAA-H comprises authentication information on the subscriber, authentication information is preferably not requested in message 2-2 and not returned in message 2-4. In other words, messages 2-2 and 2-4 may be used to transmit subscription data and location information.

If the UE knows the address of the AU-V, the UE may send message 2-1 to the AU-V, which acts similarly to the AU-H of FIG. 2. In other words, the AU-V forwards message 2-1 and message 2-6 via the AAA-V to the AAA-H, receives message 2-5 and 2-8 from the AAA-H (via the AAA-V), and adds information at point 2-9 to message 2-10. However, the AU-V does not preferably add its own address to message 2-10 since there is no need for the address. Depending on the configuration, the location information is or is not added (points 2-3 and 2-9) in the HSS and/or in the AAA-H.

The UE may be informed of the address of the AU-V using DHCP and DNS in a similar way as in IMS the address of a proxy connection state control function in the visited network is determined. Another possibility is that the address is sent during a packet data protocol context establishment or update. If the network and the UE support SLP (Service Location Protocol) it can be used to determine the address of the AU-V. Yet another possibility is that the name of the AU-V (or the service using the AU-V) is advertised and the name may be saved to the UE to be used.

In some other embodiment of the invention either the UE or the access network is configured to add to message 2-1 information indicating the location of the UE, such as information indicating the visited network. For example, the information may be Cell Global Identification (CGI) including the mobile country code (MCC) and the mobile network code (MNC). The CGI is available for example in the “P-Access-Network-Info” information element. The information may also be a label for the network or a domain, or an address of a serving node, i.e. anything which defines the location of the UE accurately enough. If the AU-H receives the information indicating the location, the AU-H may also derive location information of the UE, i.e. the visited network e.g. on the basis of the received information. In that case there is no need to add location information at points 2-3 and 2-7 or to transmit the location information in messages 2-4 and 2-8.

If the underlying network architecture has as an access network a WLAN (Wireless Local Area Network), it is also possible that the AAA-V performs some of the functions of the AAA-H.

Although it is assumed above that the relevant information is sent during application level authentication, it is obvious to a person skilled in the art that the above-described information adding may be performed during the normal authentication procedure.

Embodiment Two

FIG. 3 illustrates signalling according to embodiment two of the invention. Embodiment 2 may be used, for example, in three-phase certificate delivery comprising an authentication phase, an address determination phase and a certificate issuing phase. Embodiment 2 may also be combined with embodiment one, for example if the system is configured not to transmit the address of the AU-V to the UE in message 2-10.

In FIG. 3 it is assumed that the UE has performed a successful authentication and has a security association with the AU-H. Thus the information exchange illustrated in FIG. 3 uses an integrity protected channel. A subscriber, i.e. a user of the UE, wishes to use a service requiring a certificate from the visited network. In embodiment two of the invention the UE is configured to send the AU-H message 3-1 , which requests for the address of the AU-V. The UE is preferably configured to send message 3-1 only in response to a request relating to the visited network.

In response to receiving message 3-1, the AU-H requests in message 3-2 the location information of the UE from the HSS and receives the location information in message 3-3. Then the AU-H determines, at point 3-4, the address of the AU-V. The address may be determined as described above at point 2-9. When the address has been determined, the AU-H sends the address in message 3-5 to the UE. Message 3-5 may also comprise service related information, i.e. message 3-5 may comprise, besides or instead of the address, it may comprise the public key of the AU-V, a certificate of the AU-V, information on the protocol(s) to be used with the AU-V, and/or other security related parameters. After receiving message 3-5 the UE may send a certificate request having the address received in said message.

The UE may be arranged to indicate in message 3-1 that the UE requires an address in the visited network, for example an authenticator address. After receiving message 3-1, the AU-H may be arranged to check whether or not the request relates to an address in the subscriber's home network, and in response to the request relating to a visited network to send message 3-2 and to find out the address of the AU-V (point 3-4). The indication may be a parameter having two different values: home network and visited network. The indication may also be the address of the network node from which the service is requested, the address being given as a parameter in the request. It is also possible that a request without any address of the network node indicates that the service is to be provided (such as a certificate is to be issued) by the visited network. The indication may also be an indication indicating the required service, which may also indicate which of the networks should issue the certificate, for example. Thus, the invention does not limit how the network (or the network node) is indicated.

In another embodiment of the invention message 3-1 may be a certificate request indicating that the certificate is requested from the visited network. In this embodiment, after the address has been determined, the certificate request is either sent to the AU-V or back to the UE. In the latter case the UE is configured to send another certificate request to the AU-V, the address of which the UE received from the AU-H. If the certificate request is sent from the AU-H directly to the AU-V, message 3-5 will not be sent.

In another embodiment of the invention either the UE or the access network is configured to add to message 3-1 information indicating the location of the UE. Examples of such information are described above with embodiment one. If the AU-H receives the information indicating the location, the AU-H may also derive location information, i.e. the visited network e.g. on the basis of the received information. In that case there is no need to send messages 3-2 and 3-3. However, the AU-H may be configured to request the location information from the HSS and to check, whether or not the indicated location of the UE is the same as the one revealed by the location information in message 3-3. If not, the AU-H may be configured to use either the information received from the HSS, i.e. the information maintained in the system or the location information in message 3-3 to determine the proper address, or to send a failure indication, i.e. an error, instead of the requested information in message 3-5. The error may be sent using either the information maintained in the system or the location information in message 3-3.

The AU-H above illustrates an intermediate network node, and its features may be implemented in other intermediate network nodes, for example the AAA-H. If the intermediate network node is a node other than the AU-H, then the intermediate network node may determine the address of the AU on the basis of the location information. In that case also the address of the AU-H could be obtained from the system and would not be stored in the UE.

Although in the above it is assumed that the address of the AU-V is needed, it is obvious to a person skilled in the art that some features of the invention may be implemented when the AU is neither in the home network nor in the visited network but in some other network or when it is a separate element not belonging to any particular network. In such a case the location information of the UE cannot be utilized but the UE indicates the network or the node either by adding its address or corresponding identification information to message 2-1 or message 3-1, or the requested service indicates this network and the mapping table is then used to determine the address on the basis of the indication.

Although in the above it is assumed that the address and/or other information may be used, the AU-H (or the AAA-H) may be configured to check at point 2-9 or at point 34 whether or not the service can be provided, i.e. whether the request relating to the service can be granted and, if the service cannot be granted, to send the UE a message indicating failure. For example, the AU-H may be arranged to check whether the UE has a right to make a certificate request in the visited network or whether the UE has a right to a certificate in the network for which it requests the certificate. The check may be performed on the basis of the subscription data received from the HSS. The subscription data in the HSS may comprise information on whether or not it is allowed to issue certificates to the subscriber. The information may be just one parameter indicating whether or not this is allowed. The information may also indicate if it is allowed to issue certificates from the home network and/or visited network. It is also possible to use a combination of different parameters or to list those networks or network elements (CAs and AUs, for example) which are allowed to issue certificates. The information may also indicate whether or not it is allowed to issue authentication certificates, non-repudiation certificates, non-repudiation certificates for certain purpose, etc. The information may be common to a subscription, i.e. subscriber-specific, or subscriber-profile-specific, or common to all subscribers, e.g. operator-specific, or common to many subscribers. If the subscriber belongs to a group of subscribers, the information may be group-specific. The information may also comprise the address of the CA and/or the AU in the home network, i.e. the address of the CA-H and/or the AU-H.

Although the invention is described above assuming that the address of the AU-V and/or additional information relating to the AU-V is determined and/or transmitted, it is obvious to a person skilled in the art that similar functionality may be implemented with any other server or serving node, such as a node that stores network-specific information needed by the UE, and thus the AU-V is simply used as an example of a server/serving node.

Although the invention is described above assuming that the service is certificate issuing service, it is obvious to a person skilled in the art how to implement the invention in similar types of services where the address of the network node providing the service may depend on the location of the UE and/or where other additional information needed for the service may be transmitted from the network to the UE.

It is obvious to a person skilled in the art that different features and functions described above with specific embodiments and systems can be combined freely to create other embodiments of the invention or other systems implementing the inventive embodiments.

The telecommunication system and network nodes implementing the functionality of the present invention comprise not only state-of-the-art means but also means for providing one or more of the functionalities described above. Present network nodes and user equipment comprise processors and memory that can be utilized in the functions according to the invention. All modifications and configurations required for implementing the invention may be performed as routines, which may be implemented as added or updated software routines, application circuits (ASIC) and/or programmable circuits, such as EPLD (Electrically Programmable Logic Device) and FPGA (Field Programmable Gate Array).

It will be obvious to a person skilled in the art that as technology advances the inventive concept can be implemented in various ways. The invention and its embodiments are not limited to the examples described above but may vary within the scope of the claims.

1. A method for determining an address of a network node in a network where the subscriber currently locates in a mobile communication system, the method comprising:
maintaining in the mobile communication system subscriber's location information; and
determining on the basis of the subscriber's location information the address of the network node.

2. The method of claim 1, further comprising:
receiving in the mobile communication system a message from subscriber's user equipment, the message indicating the address of the network node;
checking whether or not the address which the message indicated corresponds to the address determined on the basis of the location information; and
if they do not correspond to each other, using the address determined on the basis of the location information.

3. The method of claim 1, further comprising:
receiving in the mobile communication system a message from subscriber's user equipment, the message including subscriber's location information;
checking whether or not the location information in the message corresponds to the location information maintained in the system; and
using the maintained location information if it does not correspond to the location information in the message.

4. A method for determining a network node address in a mobile communication system, the network node being in a location network of a subscriber, the method comprising:
receiving in the mobile communication system a message from subscriber's user equipment, the message indicating subscriber's location information; and
determining on the basis of the subscriber's location information the address of the network node.

5. The method of claim 4, wherein the message contains a global cell identifier which indicates the subscriber's location information.

6. A method for transmitting, to subscriber's user equipment, information required for a service in a mobile communication system, the method comprising:
authenticating the subscriber; and
transmitting to the user equipment at least part of the information during the subscriber authentication.

7. The method of claim 6, wherein the authentication is application level authentication.

8. The method of claim 6, wherein the service is certificate issuance service and the user equipment utilizes said part of the information during a certificate issuance procedure in a visited network.

9. The method of claim 6, wherein said part of the information is location network specific information.

10. The method of claim 6, wherein said part of the information comprises at least an address of a network node via which the service is provided.

11. The method of claim 6, wherein said part of the information comprises at least a public key required for the service.

12. The method of claim 6, wherein said part of the information comprises at least an indication of the protocol required for the service.

13. The method of claim 6, wherein the service is certificate issuance service and said part of the information comprises at least an address of a network node via which the service is provided and the method further comprising transmitting from the user equipment a certificate request to the network node.

14. A method for transmitting to subscriber's user equipment information required for a service in a mobile communication system, the method comprising:
authenticating the subscriber;
receiving a message relating to the service; and
transmitting to the user equipment in a reply message at least part of the information in response to the received message.

15. The method of claim 14, wherein the message and the reply message are transmitted in an integrity protected channel.

16. The method of claim 15, wherein the message is transmitted from the user equipment, the message is requesting an address of a network node via which the service is provided and said part of the information comprises at least the requested address..

17. The method of claim 16, further comprising transmitting from the user equipment a certificate request to the network node.

18. The method of claim 14, wherein said part of the information comprises at least a public key required for the service.

19. The method of claim 15, wherein said part of the information comprises at least an indication of the protocol required for the service.

20. The method of claim 11, wherein the message relates to a certificate issuance service.

21. A mobile communication system comprising at least user equipment and a network comprising at least a network node, the system being configured to determine a network node address in on the basis of location information of user equipment, wherein the network node is in a location network of the user equipment.

22. The system of claim 21, wherein the location network is a visited network.

23. The system of claim 21 comprising a gateway network for certificate requests in a home network of the user equipment, the gateway network being configured to perform the network node address determination.

24. The method of claim 1, further comprising:
receiving in the mobile communication system a message from subscriber's user equipment, the message including subscriber's location information;
checking whether or not the location information in the message corresponds to the location information maintained in the system; and
if it does not correspond to the location information in the message, sending an error indication by using the maintained location information.

25. The method of claim 1, further comprising:
receiving in the mobile communication system a message from subscriber's user equipment, the message including subscriber's location information;
checking whether or not the location information in the message corresponds to the location information maintained in the system; and
using the location information in the message if it does not correspond to the maintained location information.

26. The method of claim 1, further comprising:
receiving in the mobile communication system a message from subscriber's user equipment, the message including subscriber's location information;
checking whether or not the location information in the message corresponds to the location information maintained in the system; and
if it does not correspond to the maintained location information, sending an error indication by using the location information in the message.

27. A method for transmitting to subscriber's user equipment information required for a service in a mobile communication system, the method comprising:
authenticating the subscriber; and
transmitting to the user equipment at least part of the information using an authenticated channel.

28. A network node in a mobile communication system, wherein the network node (AU-H) is arranged to determine an address of another network node required for providing a service for a subscriber on the basis of subscriber's location information.

29. The network node of claim 28, wherein the network node (AU-H) is in a home network and the other network node is in a visited network.

30. User equipment in a mobile communication system, wherein the user equipment (UE) is arranged to receive at least part of the information required for a service in a location network of the user equipment after the user equipment has been authenticated.

31. The user equipment of claim 30, wherein the user equipment (UE) is arranged to receive said part of the information from a network node with which the user equipment was authenticated, the network node being in a home network.
